(19) United States
(12) Patent Application Publication
(10) Pub. No.: US 2008/0162245 A1
(43) Pub. Date: Jul. 3, 2008

(54) METHOD FOR USER ORIENTED REAL TIME CONSOLIDATION OF BUSINESS PROCESS SPECIFICATION LANGUAGE PROCESS STEPS

(75) Inventor: Niraj P. Joshi, Cary, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/619,421

(22) Filed: Jan. 3, 2007

(51) Int. Cl. G06Q 10/00

(52) U.S. Cl. 705/9

(57) ABSTRACT

A method for utilizing business process specification language to enable collaboration between roles by executing tasks in an order defined by the business process specification language process flow, while minimizing the need for a user to utilize a process execution engine to claim the tasks. The method includes determining a set of users involved in the business process specification language process flow; determining the tasks that constitute the business process specification language process flow; determining the roles involved in the business process specification language process flow; determining which individual users perform which roles; and recognizing when the individual user is performing consecutive tasks that are assigned to different roles; and wherein based on the recognition the requirement for the individual user to utilize a process execution engine to claim the consecutive tasks is eliminated.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to software that manages business processes, information transfer, and interaction that are executed by different roles in an organization, and more particularly to providing a method, article, and system for utilizing a business process specification language to enable collaboration between roles by executing tasks in an order defined by the business process specification language process flow, while minimizing the need for a user to utilize intermediate user interaction steps enforced by a user interface subsystem to claim a task by recognizing when an individual user is performing consecutive process steps that are assigned to different roles.

2. Description of the Related Art

A business process typically has steps that are executed by different roles. For example, a business process that handles travel requests and approvals for employees, can involve multiple roles including the employee (role 1), the immediate manager (role 2), a travel agent (role 3), finance (role 4), and senior management (role 5). Business process specification languages, such as Business Process Execution Language (BPEL) have a processing a engine, such as International Business Maclihie's WebSphere Process Choreographer that enables collaboration between theses roles by executing the tasks in the order defined by the BPEL process flow. Business Process Execution Language (BPEL) is an XML-based language for the formal specification of business processes and business interaction protocols. BPEL extends the Web Services interaction model and enables it to support business transactions. BPEL based applications encompass tools for developing e-business applications and middleware for running Web applications.

The simple example of a business process that handles travel requests and approvals for employees has a single individual assigned to each role; however in many cases, a person can be assigned multiple roles, and may be tasked to perform consecutive process steps.

Current process engine user interface technology, such as the IBM WebSphere Portal Server's Human Task Manager, hinders the usability of the person (user) who has to perform consecutive process steps that are assigned to different roles. A Web portal provides a single access point to Web content and applications, personalized to each user's needs. Portal software supports workflows, content management, simplified usability and administration, open standards, security and scalability. The Human Task Manager (HTM) requires the user to “claim a task” prior to performing the task associated with that process step. The present requirements of the HTM introduce additional user interface navigation operations that increase the user's time in performing consecutive process steps.

FIG. 1 illustrates a process 100 with 13 tasks that is designed to flow between 5 roles. Assuming that all the steps require a user interaction, as is typical in business-oriented processes, the user is required to execute a HTM claim task prior to executing each of the 13 separate tasks. For example, a user who performs role 2 initiates the HTM claim task process three separate times (102, 106, 110) to conduct task 2, task 5, and task 11 (104, 108, 112) respectively. If all five roles are performed by different people (users), requiring the HTM claim task process is not a problem. However, the HTM claim task process can become cumbersome, by requiring a single user to repeatedly claim the next task, while performing a consecutive series of tasks, when multiple roles are played by the same person (user).

FIG. 2 illustrates a process 200 that is similar to FIG. 1, which consisted of 13 tasks conducted by 5 roles, however in this instance role 1, role 2, and role 3 is performed by a single user, as signified by the task sequences of regions 202, 204, and 206 that overlap role 1, role 2, and role 3. Region 202 encompass three sequential process steps represented by task 1 (208), task 2 (210), and task 3 (212), that require the single user to claim the tasks at 214 and 216. In region 204 the single user must perform claim tasks 218 and 220 to conduct task 5 (222) and task 7 (224) respectively. Finally, in region 206 the single user must perform claim tasks 226, 228 and 230 to conduct task 10 (232), task 11 (234) and task 13 (236) respectively. As is evident from FIG. 2, the single user has to perform the repetitive HTM claim task seven times to conduct the eight required tasks.

### SUMMARY OF THE INVENTION

Embodiments of the present invention comprise a method for utilizing business process specification language to enable collaboration between roles by executing tasks in an order defined by the business process specification language process flow, while minimizing the need for a user to utilize a process execution engine to claim the tasks, wherein the method comprises: determining a set of users involved in the business process specification language process flow; determining the tasks that constitute the business process specification language process flow; determining the roles involved in the business process specification language process flow; determining which individual users perform which roles; recognizing when the individual user is performing consecutive tasks that are assigned to different roles; and wherein based on the recognition the requirement for the individual user to utilize the process execution engine to claim the consecutive tasks is eliminated.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a process flow with 13 tasks that is designed to flow between 5 roles.

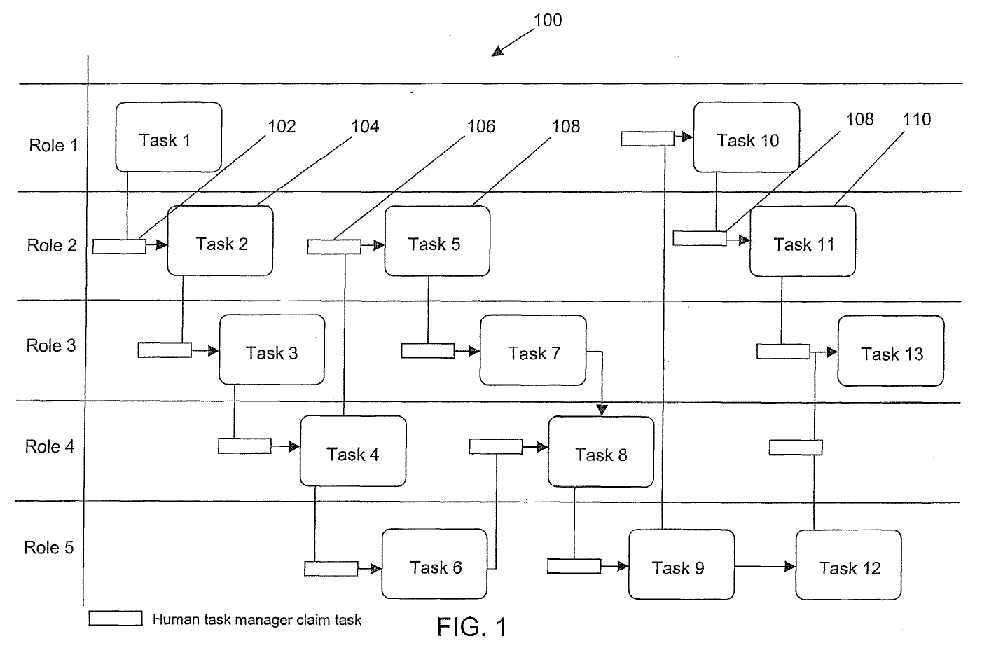

FIG. 2 illustrates a process flow with 13 tasks that is designed to flow between 5 roles, where 3 of the roles are assigned to a single user.

FIG. 3 illustrates a process flow conducted with the elimination of HTM claim tasks within a sequential sequence task assigned to a single user spanning more than one role according to an embodiment of the present invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a method, article, and system for utilizing a business process specification language, such as Business Process Execution Language (BPEL) to enable collaboration between roles by executing tasks in an order defined by the BPEL process flow, while minimizing the need for a user to utilize intermediate user interaction steps enforced by a user interface subsystem of a process execution engine, such as IBM's WebSphere Portal Server's Human Task Manager (HTM) to claim a task by recognizing when an individual user is performing consecutive process steps that are assigned to different roles.

The process execution engine of an embodiment of the present invention recognizes the pattern of consecutive tasks that will be executed by a single person (possibly across role boundaries). Examples of a process execution engine include the IBM Websphere Process Choreographer, or similar application code that controls the execution of the process/workflow. The recognition by the process execution engine of consecutive tasks and their assignments should be performed at run time, since role definition and assignment can change during the lifecycle of the process. The process execution engine of the present invention takes each instance of patterns of consecutive tasks, and consolidates the consecutive tasks by connecting them in sequence, and eliminates redundant HTM steps required by the individual user.

Table 1. provides an example embodiment of a pseudo code algorithm for the implementation of the present invention using a recursive method. It should be noted that algorithmic code employing non-recursive methods can also be used.

TABLE 1
AnalyzeProcess //This top level function kicks off the recursive algorithm to analyze the
process steps.
{
Select the process step P to execute next.
Identify the user U that is supposed to execute P.
AnalyzeStep (P, U)
}
AnalyzeStep (P, U) //Recursive function to analyze and consolidate consecutive tasks at
runtime
{
Is there a next process step P+1?
If no, exit.
Is the next process step P+1 supposed to be executed by the same user U?
//Look for user and role assignment of the process step
If yes, then
ConsolidateStep (P, P+1)
AnalyzeStep (P+1, U)
}
Consolidate (P1, P2) //Analyze each step of the process and identify consecutive tasks
that are performed by the same role.
{
Eliminate HTM claim task that was supposed to follow P1. Enable automatic claim of the
next task.
For this execution of the process, connect P1 to P2, so that execution of P1 will be
immediately followed by P2.
}

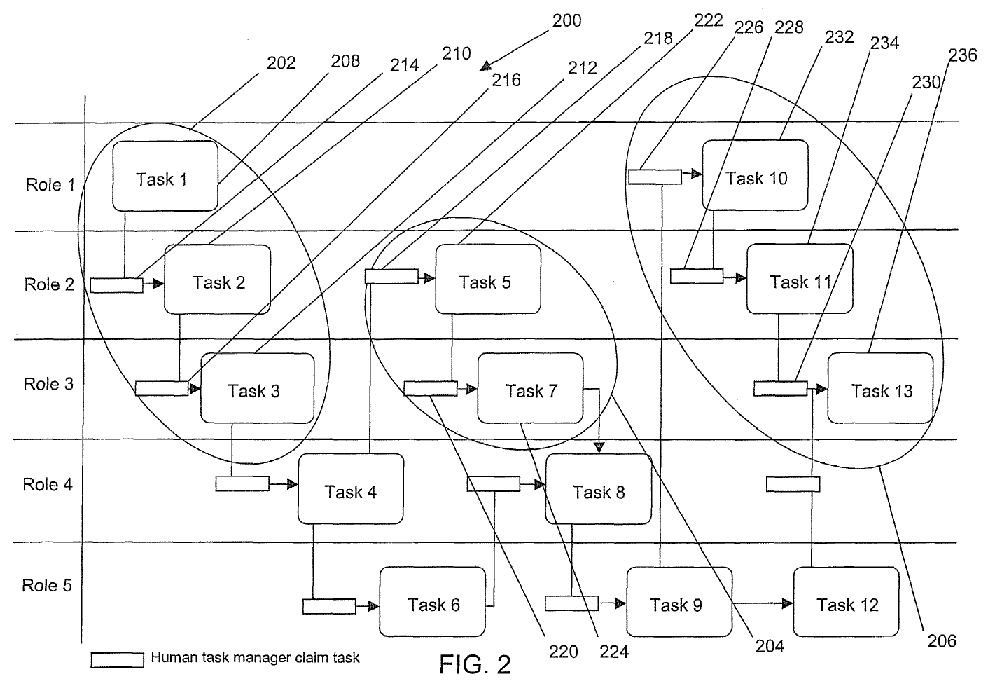

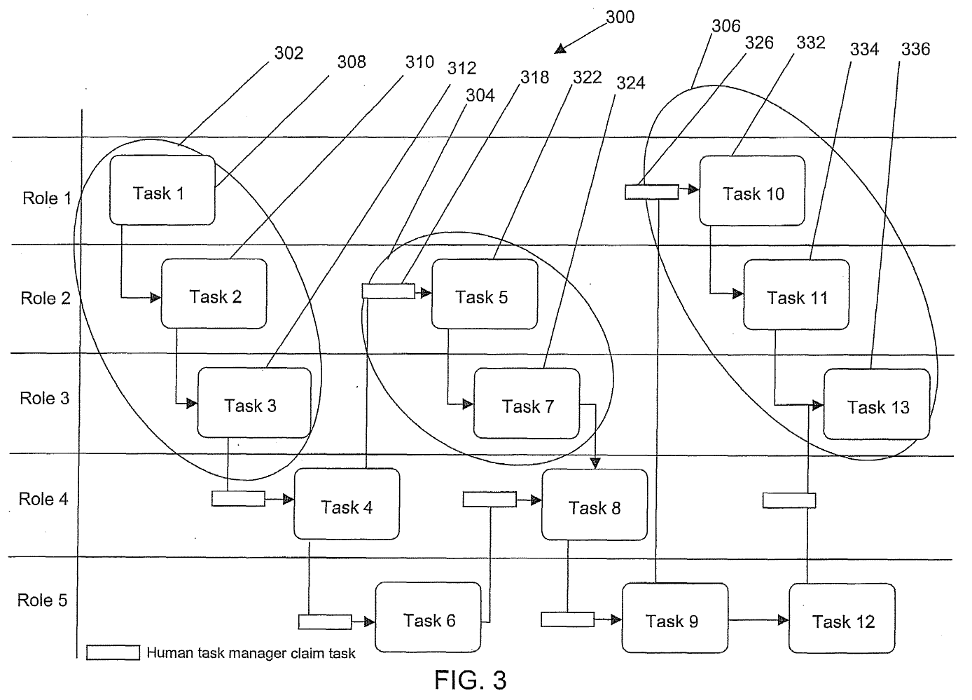

FIG. 3 illustrates a process flow 300 conducted with the elimination of HTM claim tasks within a sequential sequence task assigned to a single user spanning more than one role according to an embodiment of the present invention. The process flow and role assignments are the same as in FIG. 2, with the single user assuming role 1, role 2, and role 3 as signified by regions 302, 304, and 306. Region 302 encompass three sequential process steps represented by task 1 (308), task 2 (310), and task 3 (312), that no longer require the single user to claim the tasks, in contrast to FIG. 2 with claim task steps at 214 and 216. In region 304 the single user must perform claim task 304 to conduct task 5 (322) and task 7 (324), while omitting claim task step 220 of FIG. 2. Finally, in region 306 the single user must perform a single claim task step 326, omitting claim task steps 228 and 230 of FIG. 2, to conduct task 10 (332), task 11 (334) and task 13 (336) respectively. The omission of HTM claim task steps enhances a single users experience when they perform multiple roles, by eliminating unnecessary operations and speeding up the process flow. Table 2 summarizes the number of steps that are saved with an embodiment of the present invention (FIG. 3), in contrast to the existing process of FIG. 2.

TABLE 2
Sequence of tasks performed by single user assigned role 1,
role 2, and role 3

| FIG. 2 | FIG. 3 |
|---|---|
| Task 1 - HTM-Task 2 - HTM-Task 3 | Task 1 - Task 2 - Task 3 |
| HTM - Task 5 - HTM - Task 7 | HTM - Task 5 - Task 7 |
| HTM - Task 10 - HTM - Task 11 - | HTM - Task 10 - Task 11 - |
| HTM - Task 13 | Task 13 |
| Total tasks = 15 | Total tasks = 10 |

As can be seen from the summary presented in Table 2, an embodiment of the present invention eliminates five instances of using the HTM claim task to allow the single user to proceed to the next task in a sequence.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A method for utilizing a business process specification language to enable collaboration between roles by executing tasks in an order defined by the business process specification language process flow, while minimizing the need for a user to utilize intermediate user interaction steps enforced by a user interface subsystem of a process execution engine to claim the tasks, wherein the method comprises:
determining a set of users involved in the business process specification language process flow;
determining the tasks that constitute the business process specification language process flow;
determining the roles involved in the business process specification language process flow;
determining which individual users perform which roles as determined by the business process specification language process flow;
recognizing when the individual user is performing consecutive tasks that are assigned to different roles as determined by the business process specification language process flow; and
wherein based on when the individual user is performing consecutive tasks that are assigned to different roles, the requirement for the individual user to utilize intermediate user interaction steps enforced by the user interface subsystem of the process execution engine to claim the consecutive tasks is eliminated.

2. The method of claim 1, wherein:
the determining and recognizing is carried out by an algorithm implementing recursive routines.

3. The method of claim 1, wherein:
the determining and recognizing is carried out by an algorithm implementing non-recursive routines.

4. The method of claim 1, wherein:
the determining and recognizing is performed during process execution of the business process specification language.

5. The method of claim 4, wherein:
the determining and recognizing at runtime of the business process specification language comprises, taking each pattern of consecutive tasks and consolidating the consecutive tasks by connecting the consecutive tasks and eliminating redundant utilization of the process execution engine to claim the consecutive tasks by the individual user.

6. The method of claim 1, wherein:
the implementing of the business process specification language is facilitated with software comprising XML.

7. An article comprising machine-readable storage media containing processor-executable instructions that when executed by a processor enable a processor to enact a collaboration between roles by executing tasks in an order defined by a business process specification language process flow, while minimizing the need for a user to utilize a process execution engine to claim the tasks in a system, comprising: computer servers, mainframe computers, and user interfaces, and wherein the user interfaces further comprise: desktop computers, laptop computers, mobile computing devices, and mobile communication devices.

8. The article of claim 7 wherein the instructions further comprise algorithms implementing recursive routines.

9. The article of claim 7 wherein the instructions further comprise algorithms implementing non-recursive routines.

10. The article of claim 7 wherein the instructions further comprise an algorithm that determines, a set of users involved in the business process specification language process flow, the tasks that constitute the business process specification language process flow, the roles involved in the business process specification language process flow, and which individual users perform which roles; and
wherein the algorithm recognizes when the individual user is performing consecutive tasks that are assigned to the different roles; and
wherein the algorithm eliminates the need for the individual user to utilize a process execution engine to claim the consecutive tasks.

11. The article of claim 10 wherein the determining and recognizing of the set of users, the task, and the roles is performed during process execution of the business process specification language.

12. The article of claim 7 wherein the instructions further comprise an algorithm that takes each pattern of consecutive tasks and consolidates the consecutive tasks by connecting the consecutive tasks and eliminating redundant utilization of the process execution engine to claim the consecutive tasks by an individual user.

13. The article of claim 7 wherein the instructions are facilitated with XML.
